(19) United States
(12) Patent Application Publication
(10) Pub. No.: US 2002/0152205 A1
(43) Pub. Date: Oct. 17, 2002

(54) Method of operating an automatic sector information system

(76) Inventors: Henrik Hodam, Aachen (DE); Nils Lenke, Rheinbach (DE)

Correspondence Address: U.S. Philips Corporation, 580 White Plains Road, Tarrytown, NY, 10591, US

(21) Appl. No.: 10/117,808

(22) Filed: Apr. 8, 2002

(30) Foreign Application Priority Data
Apr. 11, 2001 (DE) 10118127.2

(51) Int. Cl. G06F 7/00

(52) U.S. Cl. 707/3

(57) ABSTRACT

A method is described for the operation of an automatic sector information system (Yellow Pages Service) in which a user by means of a terminal (1) connected to the system transmits search parameters to the system. The system then uses these search parameters to search for subscriber data (TD) stored in a system database (3) of suppliers of a sector desired by the user, and outputs corresponding subscriber data (TD) found in the database (3) to the user. The system determines information (SI) on the location of the user and the locations of the suppliers found in the database (3) and for each supplier determines a distance measurement which corresponds to a shortest route between the user and the supplier or the time required to cover the route. The subscriber data of these suppliers are output as a function of the distance measurements of the suppliers concerned. In addition, a corresponding automatic sector information system is claimed.

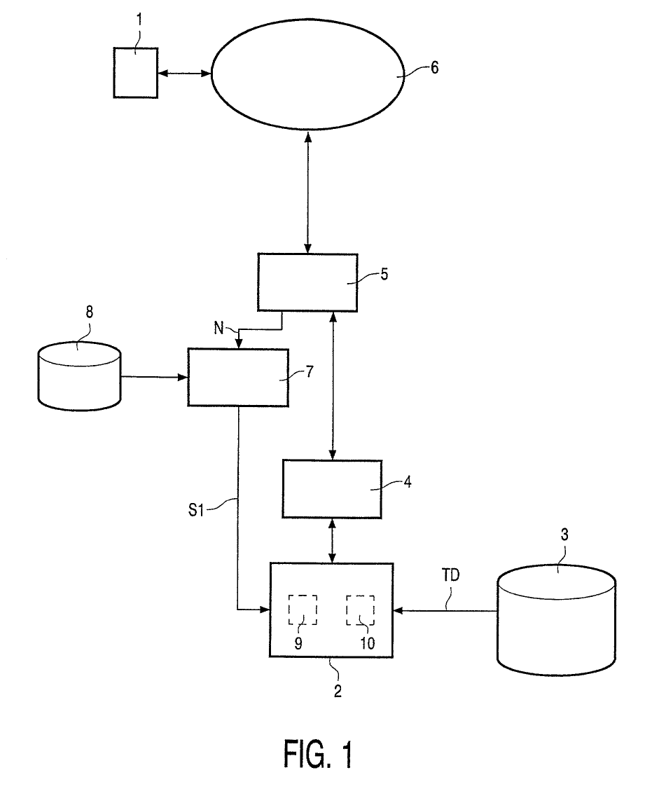

The invention relates to a method of operating an automatic sector information system in which, from search parameters transferred to the system by means of a terminal of a user, suppliers of a desired sector are sought for which the subscriber data stored in a system database correspond to the search parameters and in which then the subscriber data of at least one found supplier are output to the user. In addition the invention relates to a corresponding automatic sector information system.

Such methods or sector information systems are known for example under the name “Yellow Pages service”. By means of such a service the user can obtain information on all possible suppliers of a required sector e.g. doctors, tradesmen or other companies, but also public establishments such as police stations, swimming pools, schools etc. The term “sector” in this description has a correspondingly general meaning. The best known are such sector information systems via telephone i.e. in the form of specialized telephone information. In addition there are already such information systems in data networks for example the Internet or Intranet. The terminals depending on the type of information system are either a telephone, a mobile phone, a computer or an organizer etc. with a corresponding telephone function or, in the case of an information system in a pure data network, PCs or organizers or mobile phones with corresponding access possibilities to the network concerned, for example WAP phones. The search parameters are various search criteria e.g. the sector, special field or location, or associated search concepts e.g. “doctors” or “homeopathy” or “Munich”. The subscriber data can for example be the telephone number, address or other information which allows the user to make contact with or gain access to the supplier subscribing to the information system, i.e. entered in the information database. Also in a user-friendly sector information system, direct connection of the user to the supplier found is possible if the user so desires (call transfer).

In many cases the user is not interested in being given very many different suppliers but his main interest lies in finding the closest possible or several suppliers of a required sector located close to his current location. This is always sensible in particular if within an information system, for example in a city, there are several hundred suppliers and it is to be assumed that the user will not wish to travel a great distance to use a service. Thus for example generally it is assumed that a user will not wish to drive across the entire city simply to buy bread from a baker's shop. However, if a large number of suppliers are given to the user it is extremely difficult for him to search for the closest supplier, in particular if for example the user is not familiar with the locality. Independent searching of the physically most favorably located supplier becomes all the more difficult—if not almost impossible—in the case of pure telephone information in which there is only an acoustic output of the various suppliers in succession.

WO 99/51017 describes a special method of call transfer to the nearest branches of a supplier chain, for example a pizza delivery chain. This is a “one number” system in which the user generally calls only one universally valid number of the supply chain, for example an “0800” number, and is automatically connected with the closest branch serving the area in which the caller is located or in which he would like to take delivery. In addition, there is also the possibility of determining the distance in the form of a point-to-point distance between the co-ordinates of the location of the user concerned and the known co-ordinates of the subsidiary i.e. a pure linear distance. This method has, however, the disadvantage that it does not ensure that the branch which is closest to the supplier in terms of direct distance is necessarily actually the nearest supplier who can be reached in the shortest time. For example, the location of the branch and the location of the user may be separated by a river, a motorway or another obstacle difficult to cross, so that the actual distance for delivering a product or reaching the supplier is considerably longer than for a branch which is further away in purely linear terms. WO 99/51017 also proposes establishing “cover areas” for the individual branches in which they each supply customers, and taking these cover areas of the individual branches into account when transferring an incoming call of a user. This method does not however lead to a user who is seeking the closest supplier of a particular sector actually being given the supplier whom he can reach most quickly or most favorably.

The object of the present invention is to create a method of operating an automatic sector information system or a sector information system in which the user is given the information he requires in as user-friendly and as time-economic manner as possible, in particular for the user.

This object is achieved by a method as claimed in claim 1 or an automatic branch information system as claimed in claim 11.

According to the invention firstly information on the current location of a terminal of the user and information on the locations of the suppliers found are determined. Using this location information, then for each supplier a physical distance measurement is determined which is a distance measurement which corresponds to a distance to be covered by a supplier to the user in the given transport network with a given transport means. Alternatively, it can be the time required for the transport means concerned. Also both measurements i.e. the distance and the time can be determined and used alternatively. The term “transport means” here includes generally not only cars, bicycles, motorbikes or similar, but also covering a distance on foot or by public transport.

The relevant supplier data is then output as a function of the associated distance measurements. Firstly the individual suppliers can be sorted in relation to their distance measurement, for example such that the shorter the distance to the supplier, the higher the priority is selected on output. Also a selection can be made of which suppliers are output. Here the number of suppliers can be limited to a maximum number of suppliers output and/or only suppliers are output who are located within a particular distance from the user i.e. suppliers whose distance measurement lies below a preset maximum. In extreme cases only one supplier is output.

In this way the user is given (only) the nearest company or companies that meet his entered search parameters, for example sector and specialist field. Here the user has the advantage that these are actually suppliers who can be reached by him under real conditions in the shortest way and/or the shortest time.

To obtain information on the user's location, various information sources can be used. One possibility is the use of the “Calling Line ID” (CLID) method. Here a telephone database is used in the opposite direction in order to obtain from the number the address of the caller. The number is usually supplied simply by the telephone provider unless the caller has chosen to withhold the number. In this way the location of the user or terminal can be determined directly. Alternatively, the current location for example the address can be requested from the user. Further possibilities include, where the user's terminal is a mobile phone, using a mobile phone location system which for example gives information on the current mobile phone cell used, or which works with GPS-supported or similar systems to establish the location of the mobile phone.

The location information on the suppliers is usually contained in a database with subscriber data on suppliers, as these usually contain addresses. From the addresses using a suitable map the required co-ordinates can be generated.

In a particularly preferred example of embodiment, the search parameters are queried and/or the automatic sector information system is controlled by the user via a user dialog system which has automatic speech recognition and means for output of input requests and/or the subscriber data of the required subscriber. This user dialog system can for example be implemented by a server with suitable software, where this software contains, in addition to the menu guide, speech recognition software to detect the received speech of the user, for example via the telephone link. In order to output the input requests, for example a request such as “Specify the sector required”, or the found subscriber data of the supplier concerned, any voice output device can be used. For example a voice synthesizer can be used which compiles the required word or sentence to be output from fragments of speech. Also prestored replies in sound files can be used which are selected and retrieved from a database accordingly by the menu guide software.

The user can also control the system by means of this user dialog system either using spoken commands such as for example “Now search” or “Give further suppliers”. It is however also possible to control the system by pressing keys on the terminal, for example by means of the DTMF (Dual Tone Multi Frequency) keys normally present on a telephone. A combination of the different control methods is also possible, i.e. a combination of spoken commands and key press commands.

An automatic sector information system according to the invention requires firstly a database in which the suppliers' subscriber data are stored. In addition it requires means for entering search parameters, a search device to search for subscribers or subscriber data in the database using the search parameters, and means to output the subscriber data. The means for entering search parameters and the means for output of subscriber data are for example a network connection point, in order to make connection with the user's terminal via a telecommunication or data network, and a corresponding dialog system, so that the user with his terminal can communicate with the search device. Furthermore, this sector information system requires means for obtaining information on the current location of the user and suppliers. In addition, it requires a route determination device to determine the relevant distances between the suppliers and user.

The route determination device can in principle be a conventional navigation system or commercial navigation software such as for example is used in vehicle navigation systems. Such navigation systems are able both to determine the precise route to be taken and to estimate the average time required to cover the distance. Where the system must be able to calculate the time required to cover a route, and public transport means are to be taken into account, it is useful if the system has access to a database in which are stored the timetables of the various public transport means. In a particularly user-friendly system, in calculating the times required to cover a particular distance, where applicable specific circumstances e.g. traffic density etc. dependent on time of day or day of week etc. can be taken into account.

In addition, a selection and/or sorting device is required in order to select and sort subscriber data of the suppliers found as a function of the distance measurements determined by the route determination device. This selection and/or sorting device can be implemented in the form of software on a suitable computer. Preferably the route determination device, the selection and/or sorting device together with the search device and where applicable the dialog system and required database can be implemented on a common server, accessible via a telecommunication or data network, in the form of software and where applicable also in the form of hardware e.g. by suitable plug-in cards or similar. Also the device for determining location information, for example a CLID device, in order to find the address from the telephone number, can be integrated with the associated database and network connection point of the entire system in such a server.

Preferably the subscriber data of the suppliers concerned are output according to the user's specification either as a function of the route or as a function of the time required to cover the route. This means the user can first specify by a corresponding command whether he seeks the quickest or the shortest route. Depending on transport means, namely the suppliers who can be reached the most quickly and not necessarily the suppliers who can be reached in the shortest way are found. It is quite possible for example that when a car is used, a supplier accessible via the motorway can be reached more quickly but the effective route is longer than for a supplier to be reached for whom the user must cross several sets of traffic lights.

As well as the sorting and/or selection and output of subscriber data of the relevant suppliers to the user as a function of the associated distance measurements, the distance measurement can also be output to the user. This means the user receives not only the telephone number and for example the address of the supplier but also the route to be covered and/or the time required with a particular means of transport.

In a particularly user-friendly example of embodiment of the method according to the invention, as well as the required subscriber data the locations determined are also output for example in the form of co-ordinates and/or the routes i.e. a complete route description. This can for example be done at the request of the user after entering a corresponding command “Output route description”.

Output is possible in various ways e.g. by fax, SMS or e-mail on a PC or mobile phone of the user. The co-ordinates can be used by the user to enter in his own navigation system, e.g. in his own vehicle, where these are standard co-ordinates.

In a particularly user-friendly example of embodiment the locations or routes determined are output direct to the user's navigation system. The automatic sector information system for this naturally also requires a corresponding interface in order to transfer the data to the navigation system. Such a transfer is also possible if the locations or routes are first transmitted to the terminal, for example the mobile phone of the user and then from the mobile phone to the navigation system.

There is firstly the possibility that the sector information system calculates the route and the time required with various transport means for each supplier found, and then selects the shortest route or the shortest time and associated transport means for further comparison with other suppliers. Alternatively it is naturally also possible for the user first to specify the transport means he uses for preference, by corresponding command.

Restriction to a particular transport means reduces the calculation complexity and hence the time the system requires to search for suitable suppliers and sort these for output.

A further reduction in calculation and search time is achieved in a particularly preferred embodiment of the invention in that at least in cases where a search finds more than a preset maximum number of suppliers, first for each supplier the direct physical point-to-point distance between locations is determined. Using this direct distance a preselection is then performed so that the distance measurements are determined in a slightly more complex manner only for suppliers within a certain radius about the user's location or only for a certain number of suppliers with the smallest direct distance to the user.

A further time reduction on a search can be achieved if distance measurements and/or routes between various locations for example within an urban area are determined in advance and stored in a database, for example in a simple table. When searching for a supplier for a user, the necessary distance measurements or routes between the user's location and the location of the supplier found are first determined using the database. To keep the memory space low, it is useful here where applicable to store only the distance measurement calculated along the route determined and the selection and sort performed using this distance measurement, and finally, if the route is required for useful output to the user, the route determined again for the supplier selected. Such a database with precalculated distances need not be updated too often as distances which depend merely on the established locations and the given transport network scarcely change. Here, for example, as locations the various streets of a city or, for longer roads, certain road sections, can be used. A calling user is then allocated to one of these locations. Such a database can also be generated dynamically during one or more successive searches even over a longer period.

The use of such a simple database is particularly recommended if, using the co-ordinates, the location is first determined in a simple manner as a linear distance and only for suppliers below a particular linear distance is the precise distance via the route determined. In this case for each location there are only a limited number of other locations for which the relevant distance measurements or routes are to be stored.

The invention will be further described with reference to examples of embodiment shown in the drawings to which, however, the invention is not restricted. The features as shown below and features already described above can be essential to the invention not only in the combinations cited but also individually or in other combinations.

The sole FIGURE shows an example of embodiment of an automatic sector information system for a telephone network 6. The user can via his terminal 1, for example a normal telephone, make connection with the sector information system via this telephone network 6. For this the sector information system has a network connection point 5 which is connected to the telephone network 6.

The user's voice, transmitted via the terminal 1, the telephone network 6 and the network connection point 5 is converted in a dialog system 4 which has a speech recognition device in order to convert the speech into information which can be processed via the system, for example text information or machine-legible information. This information is then passed to a search device 2 which, using the search parameters obtained via the terminal 1, the telephone network 6, the network connection point 5 and the dialog system 4, i.e. the search criteria and search terms, selects the subscriber data TD from suppliers in the required sector for example in a particular location.

The network connection point 5 also provides at a further output the telephone number N of the terminal I of the user, provided by the supplier of the telephone network and also received over the telephone network 6. The telephone number is used in a CLID device 7 with associated database 8 to establish the address of the user or location of the terminal. This location information SI for the terminal is also passed to the search device 2. If no telephone number is given, the user's address is automatically requested by the dialog system 4.

The location information for the terminal 1 and location information for the individual suppliers which are stored in database 3 together with or as part of the subscriber data, for example as addresses, are used in a route determination device 9 within the search device 2 in order to calculate for each supplier the precise route which the user would have to cover in a given transport network with a given means of transport in order to reach the supplier.

In a subsequent selection and sorting device 10 the subscriber data of the suppliers found are then selected and sorted so that for example only the subscriber data TD are output of the five suppliers who have the shortest distance from the user, where output takes place in incremental order in relation to distance. In other words first the data of the supplier closest to the user are output and then the data of the supplier second closest to the user etc.

The information is converted back to speech for output in dialog system 4. For this the dialog system 4 has a voice synthesizer which compiles the required sentences or words from speech fragments. The output then takes place again via the network connection point 5 and the telephone network 6 of the terminal 1 of the user.

The route determination device 9 and the selection and sorting device 10 are in the present case software implementations integrated as sub-routines within the search device 2 which is also produced in the form of software on a suitable computer. These two devices are therefore shown merely for visual clarity as blocks within the search device 2 in the FIGURE. Also however the CLID device 7 and dialog system 4 with the automatic speech recognition and voice synthesizer can be implemented at least partly in the form of software and installed together with the associated databases 3 and 8 in a single server. The network connection point can for example also be integrated as a plug-in card in this computer which evidently must have the corresponding software to operate the network connection point.

In an example of embodiment not shown, the route description is also output via the network connection point. This output takes place preferably in writing for example in the form of an SMS, a fax or e-mail. It can be transferred either via the telephone network 6 or via the internet. For this it is merely necessary for the sector information system via the terminal 1 to be told to which device or which e-mail address or fax number the route information should be output. Also transfer to a navigation system, for example the user's vehicle navigation device, is possible.

The route determination device can in principle be any suitable commercial navigation software.

In a particularly simple example of embodiment, previously determined distance measurements for a number of pairs, preferably for all possible pairs, of any locations for example roads or particular road sections of a city are stored in a separate database (not shown). Via the CLID device the system obtains the address of the location of terminal 1 of the user. The address of the relevant supplier is contained in the subscriber data. Using the address or roads, access can be obtained to the tables stored and hence the previously defined distance determined. The distance measurements found can then be sorted and selected in a simple manner. According to the invention this distance measurement is selected naturally so that it corresponds to the distance actually covered or the time. If a route description must also be output, the route description between the relevant sites can be stored in this table as well as the distance dimension.

With the method according to the invention it is possible for the sector information system to give the user one entry from the sector sought which lies as close as possible to his location and can be reached via as short a route as possible, where the actual conditions of the transport network are taken into account.

1. A method of operating an automatic sector information system in which, from search parameters given to the system by means of a terminal (1) of a user, suppliers of a desired sector are sought for which the subscriber data (TD) stored in a system database (3) correspond to the search parameters and in which then the subscriber data (TD) of at least one found supplier are output to the user, characterized in that information (SI) on the current location of the user is determined, information on the locations of the suppliers found is determined, and using the location information of the user and of the relevant suppliers for each supplier at least one physical distance measurement is determined, which measurement corresponds to a route to be covered by a supplier to the user in a given transport network with a given transport means or a time required for this with said transport means, and the subscriber data of the relevant suppliers are output to the user as a function of the associated distance measurements.

2. A method as claimed in claim 1, characterized in that the search parameters are queried and/or the automatic sector information system is controlled by the user via a user dialog system (4) with automatic speech recognition and means for output of input requests and/or the subscriber data found of the suppliers in the desired sector.

3. A method as claimed in claim 1 or 2, characterized in that at least when in a search more than a preset number of suppliers are found, for each of the suppliers a direct physical distance from the user's location is first determined and a distance measurement is effected determined only for a particular number of suppliers with the shortest direct physical distances and/or for suppliers whose direct physical distance lies below a predefined maximum.

4. A method as claimed in one of the claims 1 to 3, characterized in that only the subscriber data of a particular number of suppliers with the smallest distance measurements are output and/or the subscriber data of the suppliers are output whose distance measurement lies below a predefined maximum value.

5. A method as claimed in one of the claims 1 to 4, characterized in that distance measurements and/or routes between various locations are determined in advance and stored in a database and on a search for a supplier for a user, the necessary distance measurements and/or routes between the location of the user and the location of the respective supplier found are determined using the database.

6. A method as claimed in one of the claims 1 to 5, characterized in that the route is determined for a transport means predefined by a user by means of a control.

7. A method as claimed in one of the claims 1 to 6, characterized in that by means of a control command the user predefines whether the subscriber data of the suppliers concerned should be output as a function of the length of the route or as a function of the time required to cover the route.

8. A method as claimed in one of the claims 1 to 7, characterized in that in addition to the subscriber data, the locations and/or routes determined are output.

9. A method as claimed in claim 8, characterized in that the locations and/or routes determined are transmitted to a navigation system of the user.

10. A method as claimed in one of the claims 1 to 9, characterized in that the information on the current location of the user is determined by means of a calling line identification system and/or by requesting the current location data of the user and/or by using a mobile phone location system.

11. An automatic sector information system connected for use with a terminal (1) of a user, comprising a database (3) in which are stored subscriber data (TD) of a multiplicity of suppliers of various sectors, comprising means (1, 6, 5, 4) for the user to enter search parameters, comprising a search device (2) for searching for suppliers of the desired sector in the database (3) by means of the search parameters and the subscriber data (TD), and comprising means (4, 5, 6, 1) for output of subscriber data (TD) of at least one supplier found in the desired sector, characterized by means (3, 7, 8) for determining information (SI) about the user's current location and about the suppliers found, a route determination device (9) to determine for each supplier from the user's location information (SI) and supplier concerned at least one physical distance measurement which corresponds to a route to be covered by the supplier to the user in a given transport network with a given transport means or a time desired with for this using the given transport means, and a selection and/or sorting device (10) to select and sort the subscriber data (TD) of the suppliers found as a function of the associated distance measurements for output to the user.

12. A system as claimed in claim 11, characterized by a dialog system (4) for the user to control the automatic sector information system and for the search parameters to be queried, comprising automatic speech recognition and means for output of input requests and/or the subscriber data found of the desired subscriber.

13. A system as claimed in claim 11 or 12, characterized by means for determining a direct physical distance from the location of the respective supplier to the location of the user and for preselection of suppliers for whom a distance measurement is determined by means of the route determination device (9) as a function of the respective direct physical distance and as a function of the preset maximum value for the direct physical distance and/or a preset maximum number of suppliers.

14. A system as claimed in one of the claims 11 to 13, characterized by a memory in which are stored distance measurements and/or routes between a multiplicity of locations.

15. A system as claimed in one of the claims 11 to 14, characterized by an interface for transmitting at least one determined location and/or route to a navigation system of the user.
